(19) United States
(12) Patent Application Publication
(10) Pub. No.: US 2026/0064361 A1
(43) Pub. Date: Mar. 5, 2026

(54) MEDIA CONTENT PROCESSING

(71) Applicant: Beijing Zitiao Network Technology Co., Ltd., Beijing (CN)

(72) Inventors: Linxi Ye, Beijing (CN); Jiaju Xu, Beijing (CN); Chang Yin, Beijing (CN); Shun Zhou, Beijing (CN); Weidong Hua, Beijing (CN); Jiacheng Liu, Beijing (CN)

(21) Appl. No.: 19/316,461

(22) Filed: Sep. 2, 2025

(30) Foreign Application Priority Data
Sep. 4, 2024 (CN) 202411237831.0

(51) Int. Cl. G06F 3/16; G06F 3/0482; G06F 3/0484; G11B 27/031

(52) U.S. Cl. CPC G06F 3/165; G06F 3/0482; G06F 3/0484; G11B 27/031

(57) ABSTRACT

A media content processing method, apparatus, device and a storage medium, wherein the method includes: displaying, in response to a selection of a first music, a first element corresponding to the first music in a target area of a first interface; determining style information of the first element based on an interaction operation for the first element; and generating a media resource associated with the first element, the media resource being configured to trigger: playing the first music during playback of media content associated with the media resource; and/or presenting the first element based on the style information during playback of the first music, wherein content displayed in the first element is associated with a playback process of the first music. Therefore, an element corresponding to a music can be added in the media resource, so that the content of the element changes with playback of the music.

### CROSS REFERENCE

This application claims the benefit of Chinese Patent Application No. 202411237831.0, filed on Sep. 4, 2024, entitled “MEDIA CONTENT PROCESSING METHOD, APPARATUS, DEVICE AND STORAGE MEDIUM”, the entire content of which is incorporated herein by reference.

### FIELD

Example embodiments of the present disclosure generally relate to the field of computers, and in particular, to media content processing method.

### SUMMARY

In a first aspect of the present disclosure, a method for media content processing is provided. The method comprises: displaying, in response to a selection of a first music, a first element corresponding to the first music in a target area of a first interface; determining style information of the first element in the target area based on an interaction operation for the first element; and generating a media resource associated with the first element, the media resource being configured to trigger: playing the first music during playback of media content associated with the media resource; and/or presenting the first element based on the style information during playback of the first music, wherein content displayed in the first element is associated with a playback process of the first music..

In a second aspect of the present disclosure, an apparatus for media content processing is provided. The apparatus comprises: an element displaying module, configured to display, in response to a selection of a first music, a first element corresponding to the first music in a target area of a first interface; a style information determining module, configured to determine style information of the first element in the target area based on an interaction operation for the first element; and a media resource generating module, configured to generate a media resource associated with the first element, the media resource being configured to trigger: playing the first music during playback of media content associated with the media resource; and/or presenting the first element based on the style information during playback of the first music, wherein content displayed in the first element is associated with a playback process of the first music.

In a third aspect of the present disclosure, an electronic device is provided. The device comprises at least one processor; and at least one memory, coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium having stored thereon a computer program executable by a processor to implement the method of the first aspect.

Therefore, according to embodiments of the disclosure, an element corresponding to a music can be added in a media resource, so that the content of the element changes with playback of the music.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIGS. 2A to 2H illustrate schematic diagrams of example interfaces of media content processing according to some embodiments of the present disclosure;

FIG. 3 illustrates a flowchart for media content processing according to some embodiments of the present disclosure;

FIG. 4 illustrates a schematic structural block diagram of an apparatus for media content processing according to some embodiments of the present disclosure; and

FIG. 5 illustrates a block diagram illustrating an electronic device in which one or more embodiments of the present disclosure can be implemented.

### DETAILED DESCRIPTION

It can be understood that, before the technical solutions disclosed in the embodiments of the present disclosure are used, types, usage scope, usage scenario, etc. of personal information to which the present disclosure relates should be notified to the user in an appropriate manner according to the relevant laws and regulations and the authorization of the user should be obtained.

For example, in response to receiving an active request from a user, prompt information is sent to the user to explicitly prompt the user that the requested operation will need to obtain and use the personal information of the user. Therefore, the user can autonomously select whether to provide the personal information to software or hardware such as an electronic device, an application program, a server or a storage medium, etc., which executes the operation of the technical solution of the present disclosure according to the prompt information.

As an optional but non-limiting implementation, in response to receiving the active request of the user, the way of sending the prompt information to the user may be, for example, a pop-up window, and the prompt information may be presented in a text manner in the pop-up window. In addition, the pop-up window may further carry a selection control for the user to select “agree”or “disagree”to provide personal information to the electronic device.

It may be understood that the above notification and a process obtaining of user authorization are merely illustrative, and do not constitute a limitation on implementations of the present disclosure, and other ways satisfying relevant laws and regulations may also be applied to implementations of the present disclosure.

It may be understood that the data (including but not limited to the data itself, the obtaining or use of the data) involved in the technical solution should follow the requirements of the corresponding laws and regulations and related rules.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of the embodiments may be included in any section/subsection. Furthermore, the embodiments described in any section/subsection may be combined in any manner with the same section/subsection and/or any other embodiment described in different sections/subsections.

Herein, unless explicitly stated, performing one step “in response to A” does not mean that this step is performed immediately after “A”, but may comprise one or more intermediate steps.

In the description of the embodiments of the present disclosure, the terms “including” and the like should be understood as open-ended inclusion, that is, “including, but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As used herein, the term “component” may refer to any suitable model, module, unit, or the like that is used in order to achieve a special effect. Such components may provide respective outputs based on the provided inputs, and may comprise any suitable operations, computing, or the like. One example of a component is an algorithm. Some embodiments of the present disclosure will be described below with reference to an algorithm, but it should be understood that such embodiments are also applicable to other types of components.

As briefly mentioned above, as content of various long videos and short videos is increasingly rich, people have increasingly higher aesthetic metrics for videos, and users gradually tend to add rich and interesting special effects to their videos. Conventionally, a user may perform video production by editing templates or editing materials. However, in this way, the user can only make videos in a single manner (for example, editing materials).

In view of this, embodiments of the present disclosure provide an improved solution for media content processing. According to various embodiments of the present disclosure, the terminal device displays, for the user's selection of a first music, a first element corresponding to the first music in a target area of a first interface. Correspondingly, style information of the first element in the target area is determined according to an editing operation for the first element. Then, a media resource associated with the first element is generated, the media resource is configured to trigger: playing the first music during playback of a media content associated with the media resource; and/or presenting the first element based on the style information, where the content displayed in the first element is associated with a playback process of the first music.

Therefore, the embodiment of the disclosure can add elements corresponding to music in the media resource, so that the content of the element changes according to the playback of the music, thereby enriching the content of the media resource. In addition, the embodiments of the present disclosure can also support the user to edit display styles of the elements, thereby improving the degree of freedom of editing the media content.

### Example Environment

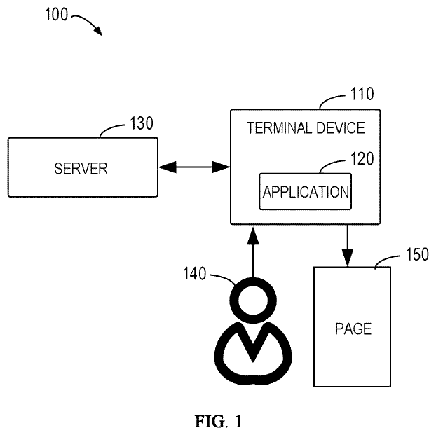

FIG. 1 illustrates a schematic diagram of an example environment 100 in which embodiments of the present disclosure can be implemented. In this example environment 100, an application 120 is installed in a terminal device 110. A user 140 may interact with the application 120 via the terminal device 110 and/or an attachment device of the terminal device 110.

In some embodiments, the application 120 may be a content sharing application, a content editing application, a content creation application, or the like. The application 120 can provide various services related to media content (which may also be referred to as media content items, content items, media items, etc.) to the user 140, including browsing, commenting, forwarding, creating (e.g., shooting and/or editing), posting, etc. of the media content.

In the environment 100 of FIG. 1, if the application 120 is active, the terminal device 110 may present an interface 150 of the application 120. The interface 150 may comprise various interfaces that can be provided by the application 120, such as a media content presentation interface, a media content creation interface, a media content posting interface, and the like. The application 120 may provide a media content editing function (e.g., the application 120 may be an editing application) to support editing (e.g., clipping) the media content in the application 120.

In some embodiments, the terminal device 110 communicates with a server 130 to enable provisioning of services for the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structures and functions of the individual elements in the environment 100 are described for exemplary purposes only without suggesting any limitation to the scope of the present disclosure.

Some example embodiments of the present disclosure will be described below with continued reference to the accompanying drawings. It should be understood that pages shown in the drawings are merely examples, and various page designs may exist in practice. Individual graphical elements in the pages may have different arrangements and different visual representations, one or more of which may be omitted or replaced, and one or more other elements may also be present. Embodiments of the present disclosure are not limited in this respect. In addition, in the following, example embodiments will be described primarily with respect to the terminal device 110. It should be understood that the actions described with respect to the terminal device 110 may be performed by the application 120 on the terminal device 110, or may be performed by the application 120 in cooperation with a serving end (e.g., the server 130).

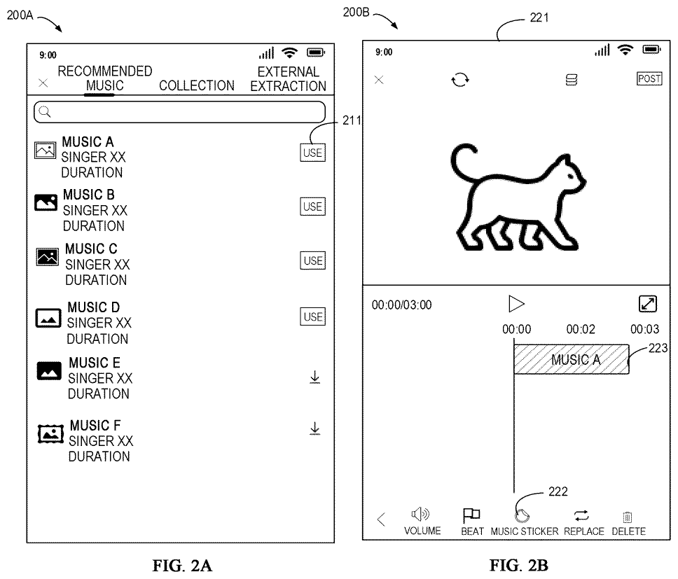

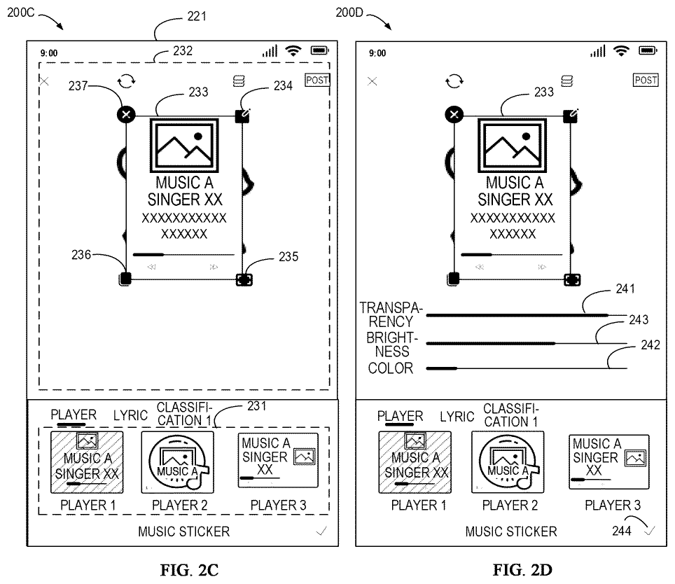

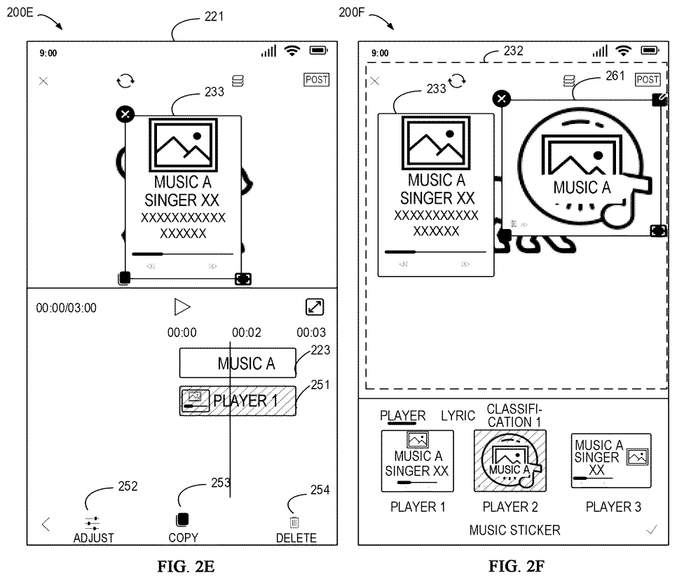

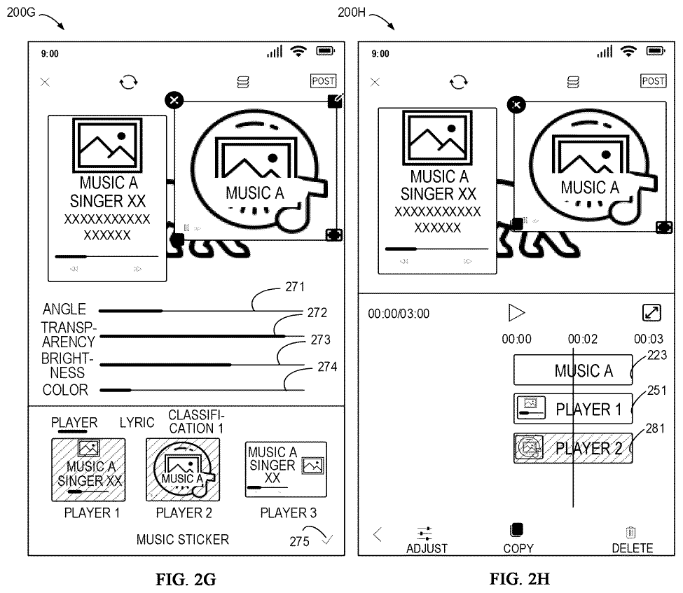

The solution for media content processing of some example embodiments of the present disclosure will be described below with reference to FIGS. 2A and 2H. However, this is merely example, which is not limited in the present disclosure. FIGS. 2A to 2H illustrate schematic diagrams of example interfaces 200A to 200H of media content processing according to some embodiments of the present disclosure. For ease of discussion, the following description will be made in the perspective of the terminal device 110.

In some embodiments, the terminal device 110 displays the first element corresponding to the first music in the target area of the first interface if the selection of the first music is detected. In some examples, in a process of creating a media resource (e.g., creating a video, creating a video template) by the user 140, if the user 140 selects the first music for the media resource, the terminal device 110 may display the first element corresponding to the first music in the target area of the first interface. In some embodiments, the first element may be, for example, a music sticker. In some examples, the music sticker may comprise different styles of stickers, covers corresponding to the music, lyrics corresponding to the music, controls for pausing and/or playing the music, controls for switching the music, and the like.

In some embodiments, the terminal device 110 may display the first element corresponding to the first music in the following manner. The terminal device 110 presents a set of candidate styles in the first interface. Then, the terminal device 110 displays the first element corresponding to a target style in the target area according to the target style selected by the user from the set of candidate styles.

As example interfaces 200A to 200C shown in FIGS. 2A to 2C, if the user 140 clicks a “use” control 211 corresponding to a music A in a process of a video or a video template, the terminal device 110 presents a “music sticker” control 222 for displaying a set of candidate styles in the first interface 221. In some embodiments, if the user 140 does not click on the “music stickers” control 222, the terminal device 110 will present prompt information for prompting the user 140 in an area associated with the “music stickers” control 222. For example, the “music stickers”control 222 is highlighted.

If detecting that the user 140 clicks on the “music stickers” control 222, the terminal device 110 presents a set of candidate styles 231 in the first interface 221. Subsequently, the user 140 may select the target style from the set of candidate styles 231. If the user 140 selects a style “player 1”, the terminal device 110 displays the first element 233 corresponding to the style “player 1”in the area 232.

In some embodiments, the set of candidate styles corresponds to different styles of music playback components. In some examples, the terminal device 110 may present different kinds of music components, such as a music playback component of a player type, a music playback component of a lyrics type, and the like. In some embodiments, content (e.g., lyrics) included in the first elements corresponding to the different styles of music playback components may be of different types. For example, the content (e.g., lyrics) included in the first element presented in “player 1” may be a wrap-around type. The content (e.g., lyrics) included in the first element presented in “player 2” may be a flat type, and so on. In some examples, the content (e.g., lyrics) included in the first element presented in the music playback component of the lyrics type may also be of a wrap-around type, a flat type, or the like.

In some embodiments, the user 140 may select a plurality of target styles, that is, if the user 140 selects a plurality of target styles, the terminal device 110 displays the first element s corresponding to the target styles in the target area. As an example interface 200F shown in FIG. 2F, if the user 140 selects the style “player 1” and the style “player 2”, the terminal device 110 displays the first element 233 corresponding to the style “player 1” and a first element 261 corresponding to the style “player 2” in the area 232. In some examples, the user 140 may further select a music playback component of the player type and a music playback component of the lyrics type. In this case, the terminal device 110 presents the first elements respectively corresponding to both types of the music playback components.

In some embodiments, the terminal device 110 determines style information of the first element in the target area according to an interaction operation for the first element. In some examples, after displaying the first element by the terminal device 110, the user 140 may edit the first element, and the terminal device 110 determines, based on the interaction operation performed by the user 140 for the first element, the style information of the first element in the target area. For example, if the terminal device 110 receives that the user 140 edits the first element presented in the style “player 1”, the terminal device 110 presents the first element in the edited style “player 1” in the target area.

In some embodiments, the terminal device 110 may determine the style information of the first element in the target area in the following manner. The terminal device 110 may provide at least one editing control associated with the first element. Then, the terminal device 110 determines the style information of the first element in the target area according to the interaction operation received via the at least one editing control. In some examples, the user 140 may click at least one editing control provided by the terminal device 110 to edit the style information of the first element in the target area.

In some embodiments, the at least one control may be used for editing a position of the first element. As an example interface 200C shown in FIG. 2C, the user 140 clicks on the corresponding intermediate position of the first element 233, and the position at which the first element 233 is presented may be adjusted. In some examples, in the process of adjusting the position at which the first element is presented, the terminal device 110 further presents an auxiliary line centered horizontally and vertically. In some embodiments, the at least one control may be used for editing angles of the first element. As the example interface 200C shown in FIG. 2C, the user 140 clicks on an edit control 235 associated with the first element 233, and the angle at which the first element 233 is presented may be adjusted.

In some embodiments, the at least one control may be used for editing a size of the first element. As the example interface 200C shown in FIG. 2C, the user 140 clicks on the edit control 235 associated with the first element 233, and may adjust the size of the first element 233 being presented. In some embodiments, the user 140 clicks on the edit control 236 associated with the first element 233, and may copy the first element 233. The user 140 clicks on the edit control 237 associated with the first element 233, and may delete the first element 233.

In some embodiments, the at least one control may be used for editing the transparency of the first element. As the example interfaces 200C shown in FIGS. 2C to 2D, the user 140 clicks on an edit control 234 associated with the first element 233, and the terminal device 110 may present a slide bar 241 for adjusting the transparency of the first element 233. The user 140 may slide the slide bar 241 to dynamically adjust the transparency of the first element 233. In some embodiments, the at least one control may be used for editing colors of the first element. As the example interface 200C shown in FIGS. 2C to 2D, the user 140 clicks on the edit control 234 associated with the first element 233, and the terminal device 110 may present a slide bar 242 for adjusting the color of the first element 233. The user 140 may slide the slide bar 242 to dynamically adjust the color of the first element 233.

In some embodiments, adjustable items corresponding to different categories of music playback components are different. For example, the items that may be adjusted for the first element 233 corresponding to the player category “player 1” may be transparency, brightness, color. The user 140 may adjust the transparency, color and brightness, respectively, by sliding the slide bars 241, 242, 243. The items that may be adjusted for the first element 261 corresponding to the player category “player 2” may be angle, transparency, brightness, color. The user 140 may adjust the angle, transparency, brightness, and color by sliding the sliding rods 271, 272, 273, and 274, respectively.

In some embodiments, the at least one control may also be used for editing a style of the content of the first element. In some examples, the user 140 may click on an editing control associated with the first element to adjust the style of a preset content. It may be understood that the user 140 may adjust the style of the lyrics corresponding to the first music, which is presented in the first element. For example, the user 140 may adjust the size, color, and type of a font corresponding to the lyrics.

In some embodiments, the terminal device 110 generates a media resource associated with the first element. In some examples, after determining the style information of the first element in the target area, the terminal device 110 generates the media resource associated with the first element, for example, a video, a video template, etc., associated with the first element. In some embodiments, the media resource is configured to trigger playback of the first music during playback of the media content associated with the media resource. Correspondingly, during the playback of the first music, the terminal device 110 presents the first element according to the style information. In some embodiments, the content displayed by the first element is associated with a playback process of the first music.

In some examples, if the user 140 selects to present the first element in the style “player 1” and edits the style information of the first element, the terminal device 110 generates a media content (e.g., a video content) or a media template (e.g., a video template) based on the first element after editing the style information. In some examples, if user 140 selects to generate a video content, the user 140 may directly post the video content. It may be understood that, in the process of playback of the media content associated to the media resource, the terminal device 110 synchronously presents the music and the content (e.g., lyrics) displayed by the first element in the media content in the form of an edited style “player 1”.

In some examples, in the process of playback of the media content associated to the media resource, the terminal device 110 may also synchronously present a music A, a playback process control related to the music A, a duration, a waveform, and a graphics corresponding to the lyrics in the media content in the form of the edited style “player 1”.

In some embodiments, where the user 140 selects to generate the media template, a first media content that applies the media template may be taken as the media content associated with the media template. For example, if the user 140 selects to generate the video template, the user 140 may post the video template for other users to use the video template.

In some embodiments, the first interface presented by the terminal device 110 may be further used for editing a second media content. In this case, the target area in the first interface is used to display the second media content to be edited. Correspondingly, the media resource created by the user 140 comprises the edited target media content. It may be understood that, after the user 140 posts the video template, other users (e.g., user B) may use the video template to generate another media content.

In some embodiments, the content displayed by the first element comprises lyrics content corresponding to a playback process of the first music. In some examples, in a first music playback process, the lyrics of the first music presented by the terminal device 110 in the first element are lyrics corresponding to a current playback location. As shown in FIG. 2C, if the user 140 selects to add the music component “player 1” of the player type, the content displayed by the first element 233 finally presented by the terminal device 110 in the area 232 may be a background corresponding to the music A (which may also be referred to as a cover of the music A) 234, a cover corresponding to the “player 1”, a singer corresponding to the music A, the lyrics corresponding to the music A during the playback of the music A and the duration corresponding to the music A, and the like. In some examples, the cover of “player 1” and the cover of the music A may be displayed in a coincident manner. In some examples, if the user 140 selects to add the music component of the lyrics type, the content displayed by the first element 233 finally presented by the terminal device 110 in the area 232 is the lyrics corresponding to the music A during the playback of the music A.

In some embodiments, the media resource is further configured to trigger the terminal device 110 to stop presenting the first element if first music playback ends. In some examples, if the first music playback ends, the first element may also be stopped displaying in the target area. In some embodiments, since the first music and the first element are strongly bound, the first element is also deleted at the same time after the first music is deleted. In some examples, if the terminal device 110 detects the operation of deleting the first music, the terminal device 110 may present a reconfirmation pop-up window. Accordingly, the terminal device 110 may present the prompt information “The first element is also to be deleted”in the reconfirmation pop-up window.

In some embodiments, the terminal device 110 further displays a target track corresponding to the first element in the first interface. In some embodiments, time distribution of the target track is aligned with the time distribution of the music track, and the music track corresponds to the selected first music. As example interfaces 200D to 200E shown in FIGS. 2D to 2E, after the user 140 selects to present the first element 233 in the style “player 1” and edits the style information of the first element 233, the user 140 may click on a completion control 244. If detecting that the user 140 clicks on the completion control 244, the terminal device 110 may display, in the first interface, a track 251 corresponding to the first element 233 and a track 252 corresponding to the music A. In some examples, the time distribution of the track 251 corresponding to the first element is aligned with the time distribution of the track 252 corresponding to the music A.

In some embodiments, if the terminal device 110 detects a modification to the music track, the terminal device 110 adjusts the target track. In some examples, if the user 140 modifies the music track, the terminal device 110 automatically adjusts the target track according to the music track. For example, if the audio added by the user 140 is a part of the music A, the time distribution of the track 252 corresponding to the music A also corresponds to the part of the music A that is added. In this case, the terminal device 110 automatically aligns the time distribution of the track 251 corresponding to the first element with the time distribution of the track 252.

As example interfaces 200G to 200H shown in FIGS. 2G to 2H, after the user 140 selects to present the first element 233 and the first element 261 with the styles “player 1” and “player 2” and edits the style information of the first element 233 and the first element 261, the user 140 may click on the completion control 275. If detecting that the user 140 clicks on the completion control 275, the terminal device 110 may display, in the first interface, the track 251 corresponding to the first element 233, the track 281 corresponding to the first element 261, and the track 223 corresponding to the music A. In some examples, the time distribution of the track 251 corresponding to the first element 233 and the time of the track 281 corresponding to the first element 261 and the track 252 corresponding to the music A are respectively aligned.

In some embodiments, the terminal device 110 may further present, in the first interface presenting the target track and the music track, a corresponding control for receiving an editing operation for the first element. As an example interface 200E shown in FIG. 2E, when the track 251 is in a selected state, the user 140 may also click on an adjustment control 252 to adjust the first element 233 corresponding to the track 251. When the track 251 is in the selected state, the user 140 may also click on a copy control 253 to copy the first element 233 corresponding to the track 251. When the track 251 is in the selected state, the user 140 may also click on a delete control 254 to adjust the first element 233 corresponding to the track 251.

In some embodiments, if detecting a selection of a second music, the terminal device 110 adds a second element corresponding to the second music in the target area. Accordingly, the media resource is configured to trigger: playing the second music during playback of the media content associated with the media resource, and presenting the second element during the playback of the second music.

In some examples, if detecting that the user 140 adds a B music, the terminal device 110 may add a second element corresponding to the B music in the area 232. During play back of the media content associated to the media resource, the terminal device 110 synchronously presents the B music and the content (e.g., lyrics) displayed by the second element in the media content in the form of a second element. In some examples, where the music A and the first element have been selected, if the music A is switched to the B music, the terminal device 110 may display the B music and associated content of the B music as presented in the form of the first element.

In summary, according to the embodiments of the present disclosure, the elements corresponding to the music are added into the media resource, so as to display the content associated to the music (e.g., lyrics, playback process controls of the music, etc.) with different types while playing the music in real time. Further, by editing the display style of the element, the degree of freedom of editing the media content is improved, and the interaction experience of the user is improved.

### Example Processes

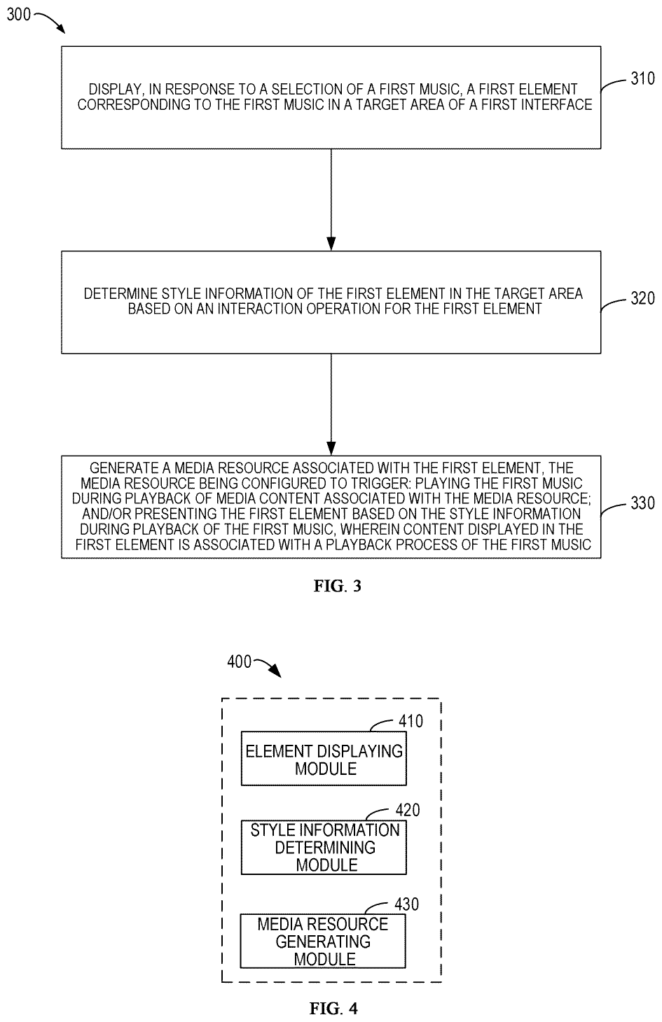

FIG. 3 shows a flowchart of a process 300 for media content processing according to some embodiments of the present disclosure. The process 300 may be implemented at the terminal device 110. The process 300 is described below with reference to FIG. 1.

At block 310, the terminal device 110 displays, in response to a selection of a first music, a first element corresponding to the first music in a target area of a first interface.

In block 320, the terminal device 110 determines style information of the first element in the target area based on an interaction operation for the first element.

At block 330, the terminal device 110 generates a media resource associated with the first element, the media resource being configured to trigger: playing the first music during playback of the media content associated with the media resource; and/or presenting the first element based on the style information, wherein content displayed in the first element is associated with a playback process of the first music.

In some embodiments, displaying, in response to the selection of the first music, the first element corresponding to the first music in the target area of the first interface comprises: presenting a set of candidate styles in the first interface; and displaying, in response to a selection of a target style of the set of candidate styles, the first element corresponding to the target style in the target area.

In some embodiments, the set of candidate styles corresponds to different styles of music playback components.

In some embodiments, determining the style information of the first element in the target area based on the interaction operation for the first element comprises: providing at least one editing control associated with the first element; and determining the style information of the first element in the target area based on the interaction operation received via the at least one editing control.

In some embodiments, the at least one editing control is used for editing at least one of the following attributes: a position of the first element; an angle of the first element; transparency of the first element; a size of the first element; a color of the first element; a style of a preset content in the first element.

In some embodiments, the process 300 further comprises: displaying, in the first interface, a target track corresponding to the first element, where a time distribution of the target track is aligned with a time distribution of the music track, and the music track corresponds to the selected first music.

In some embodiments, the process 300 further comprises adjusting the target track in response to a modification to the music track.

In some embodiments, the process 300 further comprises: adding, in response to a selection of a second music, a second element corresponding to the second music in the target area; and the media resource being further configured to trigger: playing the second music during playback of the media content associated with the media resource; and presenting the second element during playback of the second music.

In some embodiments, the content displayed by the first element comprises lyrics content corresponding to a playback process of the first music.

In some embodiments, the media resource is further configured to trigger: stopping to present the first element in response to an end of first music playback.

In some embodiments, the media resource comprises a media template and the media content comprises a first media content applying the media template.

In some embodiments, the first interface is used for editing a second media content, the target area displays the second media content to be edited, and the media resource comprises the edited target media content.

### Example Apparatus and Device

FIG. 4 illustrates a schematic structural block diagram of an apparatus 400 for media content processing according to some embodiments of the present disclosure. The apparatus 400 may be implemented or comprised in the terminal device 110. The various modules/components in the apparatus 400 may be implemented by hardware, software, firmware, or any combination thereof.

As shown, the apparatus 400 comprises an element displaying module 410 configured to display, in response to a selection of a first music, a first element corresponding to the first music in a target area of a first interface. The apparatus 400 comprises a style information determining module 420 configured to determine style information of the first element in the target area based on an interaction operation for the first element. The apparatus 400 comprises a media resource generating module 430 configured to generate a media resource associated with a first element, the media resource being configured to trigger: playing the first music during playback of the media content associated with the media resource; and/or presenting the first element based on the style information, wherein the content displayed in the first element is associated with a playback process of the first music.

In some embodiments, the element displaying module 410 is further configured to present a set of candidate styles in the first interface, and display, in response to a selection of a target style of the set of candidate styles, the first element corresponding to the target style in the target area.

In some embodiments, the set of candidate styles corresponds to different styles of music playback components.

In some embodiments, the style information determining module 420 is further configured to provide at least one editing control associated with the first element; and determine style information of the first element in the target area based on the interaction operation received via the at least one editing control.

In some embodiments, the at least one editing control is used for editing at least one of the following attributes of the first element: a position of the first element; an angle of the first element; transparency of the first element; a size of the first element; a color of the first element; a style of a preset content in the first element.

In some embodiments, the apparatus 400 further comprises a track display module configured to display a target track corresponding to the first element in the first interface, wherein time distribution of the target track is aligned with time distribution of the music track, and the music track corresponds to a selected first music.

In some embodiments, the apparatus 400 further comprises a track adjustment module configured to adjust the target track in response to a modification to the music track.

In some embodiments, the apparatus 400 further comprises an element adding module configured to add a second element corresponding to the second music in the target area in response to selection of the second music; and the media resource is further configured to trigger: playing the second music during playback of the media content associated with the media resource; and presenting the second element during playback of the second music.

In some embodiments, the content displayed by the first element comprises lyrics content corresponding to a playback process of the first music.

In some embodiments, the media resource is further configured to trigger: stopping to present the first element in response to an end of first music playback.

In some embodiments, the media resource comprises a media template and the media content comprises a first media content applying the media template.

In some embodiments, the first interface is used for editing a second media content, the target area displays the second media content to be edited, and the media resource comprises the edited target media content.

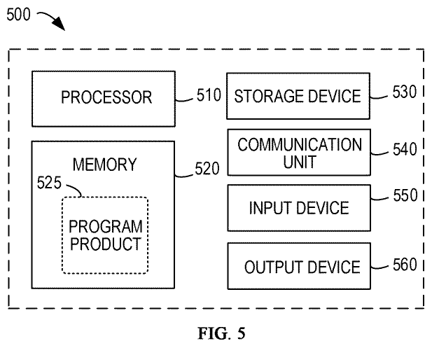

FIG. 5 illustrates a block diagram illustrating an electronic device 500 in which one or more embodiments of the present disclosure can be implemented. It should be understood that the electronic device 500 shown in FIG. 5 is merely exemplary and should not constitute any limitation on the function and scope of the embodiments described herein. The electronic device 500 shown in FIG. 5 may be used to implement the terminal device 110 in FIG. 1.

As shown in FIG. 5, the electronic device 500 is in the form of a general-purpose electronic device. Components of the electronic device 500 may comprise, but are not limited to, one or more processors or processing units 510, a memory 520, a storage device 530, one or more communication units 540, one or more input devices 550, and one or more output devices 560. The processor 510 may be an actual or virtual processor and capable of performing various processes according to programs stored in the memory 520. In multi-processor systems, multiple processors execute computer-executable instructions in parallel to improve parallel processing capabilities of the electronic device 500.

The electronic device 500 typically comprises a plurality of computer storage medium. Such medium may be any available medium accessible to the electronic device 500, including, but not limited to, volatile and non-volatile medium, removable and non-removable medium. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may comprise a machine-readable medium, such as a flash drive, a magnetic disk, or any other medium, which may be capable of storing information and/or data and may be accessed within electronic device 500.

The electronic device 500 may further comprise additional removable/non-removable, volatile/non-volatile storage medium. Although not shown in FIG. 5, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 520 may comprise a computer program product 525 having one or more program modules configured to perform various methods or actions of various embodiments of the present disclosure.

The communication unit 540 enables communication with other electronic devices through a communication medium. Additionally, the function of components of the electronic device 500 may be implemented in a single computing cluster or multiple computing machines which are capable of communicating over a communication connection. Thus, the electronic device 500 may operate in a networked environment using logical connections with one or more other servers, network personal computers (PC), or another network node.

The input device 550 may be one or more input devices, for example, a mouse, a keyboard, a trackball, or the like. The output device 560 may be one or more output devices, for example, a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to exemplary implementations of the present disclosure, there is provided a computer-readable storage medium having computer-executable instructions stored thereon, wherein the computer-executable instructions are executed by a processor to implement the method described above. According to exemplary implementations of the present disclosure, there is also provided a computer program product tangibly stored on a non-transitory computer-readable medium and including computer-executable instructions, the computer-executable instructions being executed by the processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by the processor of a computer or other programmable data processing apparatus, produce means to implement the functions/acts specified in the flowchart and/or block diagram. These computer-readable program instructions may also be stored in a computer-readable storage medium, these instructions cause the computer, programmable data processing apparatus, and/or other devices to function in a particular manner, such that the computer-readable medium storing instructions comprises an article of manufacture including instructions to implement aspects of the functions/acts specified in one or more blocks in the flowchart and/or block diagram(s).

The computer-readable program instructions may be loaded onto a computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart and/or block diagram block.

The flowchart and block diagrams in the drawings show the architecture, function, and operation of possible implementations of systems, methods, and computer program products according to various implementations of the present disclosure. In this respect, each block in the flowchart or block diagram may represent a module, a program segment, or a part of instructions, which comprises one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or the improvements to techniques in the marketplace, or to enable others of ordinary skill in the art to understand the various implementations disclosed herein.

1. A method for media content processing comprising:
displaying, in response to a selection of a first music, a first element corresponding to the first music in a target area of a first interface;
determining style information of the first element in the target area based on an interaction operation for the first element; and
generating a media resource associated with the first element, the media resource being configured to trigger: playing the first music during playback of media content associated with the media resource; and/or presenting the first element based on the style information during playback of the first music, wherein content displayed in the first element is associated with a playback process of the first music.

2. The method of claim 1, wherein displaying, in response to the selection of the first music, the first element corresponding to the first music in the target area of the first interface comprises:
presenting a set of candidate styles in the first interface; and
displaying, in response to a selection of a target style of the set of candidate styles, the first element corresponding to the target style in the target area.

3. The method of claim 2, wherein the set of candidate styles corresponds to different styles of music playback components.

4. The method of claim 1, wherein determining the style information of the first element in the target area based on the interaction operation for the first element comprises:
providing at least one editing control associated with the first element; and
determining the style information of the first element in the target area based on the interaction operation received via the at least one editing control.

5. The method of claim 4, wherein the at least one editing control is used for editing at least one of the following attributes of the first element:
a position of the first element;
an angle of the first element;
transparency of the first element;
a size of the first element;
a color of the first element;
a style of content in the first element.

6. The method of claim 1, further comprising:
displaying a target track corresponding to the first element in the first interface, wherein time distribution of the target track is aligned with time distribution of a music track, and the music track corresponds to the selected first music.

7. The method of claim 6, further comprising:
adjusting the target track in response to a modification to the music track.

8. The method of claim 1, further comprising:
adding, in response to a selection of a second music, a second element corresponding to the second music in the target area;
and the media resource being further configured to trigger: playing the second music during the playback of the media content associated with the media resource; and presenting the second element during playback of the second music.

9. The method of claim 1, wherein the content displayed by the first element comprises lyrics content corresponding to the playback process of the first music.

10. The method of claim 1, wherein the media resource is further configured to trigger:
stopping to present the first element in response to an end of first music playback.

11. The method of claim 1, wherein the media resource comprises a media template and the media content comprises a first media content applying the media template.

12. The method of claim 1, wherein the first interface is used for editing second media content, the target area displays the second media content to be edited, and the media resource comprises edited target media content.

13. An electronic device comprising:
at least one processor; and
at least one memory, coupled to the at least one processor and storing instructions for execution by the at least one processor, the instructions, when executed by the at least one processor, causing the electronic device to perform a method comprising:
displaying, in response to a selection of a first music, a first element corresponding to the first music in a target area of a first interface ;
determining style information of the first element in the target area based on an interaction operation for the first element; and
generating a media resource associated with the first element, the media resource being configured to trigger: playing the first music during playback of media content associated with the media resource; and/or presenting the first element based on the style information during playback of the first music, wherein content displayed in the first element is associated with a playback process of the first music.

14. The electronic device of claim 13, wherein displaying, in response to the selection of the first music, the first element corresponding to the first music in the target area of the first interface comprises:
presenting a set of candidate styles in the first interface; and
displaying, in response to a selection of a target style of the set of candidate styles, the first element corresponding to the target style in the target area.

15. The electronic device of claim 14, wherein the set of candidate styles corresponds to different styles of music playback components.

16. The electronic device of claim 13, wherein determining the style information of the first element in the target area based on the interaction operation for the first element comprises:
providing at least one editing control associated with the first element; and
determining the style information of the first element in the target area based on the interaction operation received via the at least one editing control.

17. The electronic device of claim 16, wherein the at least one editing control is used for editing at least one of the following attributes of the first element:
a position of the first element;
an angle of the first element;
transparency of the first element;
a size of the first element;
a color of the first element;
a style of content in the first element.

18. The electronic device of claim 13, wherein the content displayed by the first element comprises lyrics content corresponding to the playback process of the first music.

19. The electronic device of claim 13, wherein the media resource is further configured to trigger: stopping to present the first element in response to an end of first music playback.

20. A non-transitory computer-readable storage medium having stored thereon a computer program executable by a processor to implement a method comprising:
displaying, in response to a selection of a first music, a first element corresponding to the first music in a target area of a first interface;
determining style information of the first element in the target area based on an interaction operation for the first element; and
generating a media resource associated with the first element, the media resource being configured to trigger: playing the first music during playback of media content associated with the media resource; and/or presenting the first element based on the style information during playback of the first music, wherein content displayed in the first element is associated with a playback process of the first music.
